(19) United States
(12) Patent Application Publication
(10) Pub. No.: US 2026/0257518 A1
(43) Pub. Date: Sep. 3, 2026

(54) TIRES COMPRISING ANALOGOUS CUTS OF DIFFERENT WIDTHS

(71) Applicant: COMPAGNIE GENERALE DES ETABLISSEMENTS MICHELIN, Clermont-Ferrand (FR)

(72) Inventor: BENOIT DURAND-GASSELIN, Clermont-Ferrand (FR)

(21) Appl. No.: 19/163,569

(22) PCT Filed: Mar. 7, 2024
(86) PCT No.: PCT/EP2024/056087

§ 371 Date: Sep. 9, 2025

(30) Foreign Application Priority Data
Mar. 9, 2023 (FR) FR2302161

(51) Int. Cl. B60C 11/03

(52) U.S. Cl. CPC B60C 11/0306; B60C 11/0304; B60C 2011/0372

(57) ABSTRACT

A tire (10) comprises a tread comprising a circumferential rib (28, 30, 32) and first and second cuts. The first cut has a length along the axial direction (Y) that is different from the length along the axial direction (Y) of the second cut (40). An angle formed by the direction of the first portion and the direction of the second portion of the first cut (38) is substantially equal to an angle formed by the direction of the first portion and the direction of the second portion of the second cut (40). An angle formed by the direction of the second portion and the direction of the third portion of the first cut (38) is substantially equal to an angle formed by the direction of the second portion and the direction of the third portion of the second cut (40).

The present invention relates to a pair of tyres and to a tyre. A tyre is understood to be a casing intended to form a cavity by cooperating with a support element, for example a rim, this cavity being able to be pressurized to a pressure higher than atmospheric pressure. A tyre of the invention has a structure of substantially toric shape exhibiting symmetry of revolution about a main axis of the tyre.

Tyres for passenger vehicles comprising a tread comprising circumferential ribs and cuts made in each of the circumferential ribs are known from the prior art, in particular from FR3012767. The cuts comprise first, second and third portions joined directly together by first and second inflection zones that are each characterized by an angle formed by the mean direction of the first portion and the mean direction of the second portion and by the mean direction of the second portion and the mean direction of the third portion.

Within a single tyre range, there are several sizes. In particular, the different sizes have different section widths. Thus, a tyre of the size 205/55R16 has a nominal section width strictly less than a tyre of the size 255/60R18.

When designing the different sizes, the tyre designer has to adapt the geometry of the different tread pattern elements, in particular the axial length of the circumferential ribs. Thus, in order to maintain a substantially constant void ratio, the axial length of the circumferential ribs of the tyre of the size 255/60R18 is greater than the axial length of the circumferential ribs of the tyre of the size 205/55R16 .

However, the greater the axial width of a circumferential rib, the greater the axial length of the cuts made in this circumferential rib. Thus, the designer will provide cuts of different axial lengths by homothetically modifying a reference cut. This homothetic modification brings about, in particular, a modification in the angle of the first and second inflection zones. Thus, in a range of tyres, there may be as many angles of each first and second inflection zones as there are tyre section widths.

In order to mould each cut, use is made of moulding elements, known, for example, as sipe blades when the widths of the cuts are relatively small. These moulding elements have a shape complementary to the cuts that they are intended to mould in the tyre and are usually manufactured by pressing a metal plate. In order to provide the angle of the inflection zone, it is therefore necessary to use as many pressing tools as there are different angles. In order to manufacture a range of tyres, the number of tools to be used is therefore relatively high, making the moulding elements expensive and time-consuming to manufacture.

Moreover, in order to reduce the noise generated by these tyres, each cut opens into each of the first and circumferential cuts delimiting one and the same circumferential rib respectively in first and second opening zones such that the azimuth of a point of the first opening zone of one of the cuts is substantially aligned circumferentially with the azimuth of a point of the second opening zone of another of the cuts made in this same circumferential rib.

Thus, in addition to the relatively large number of tools, the complexity of their design is increased on account of the constraint of arrangement of the above-described azimuths.

The aim of the invention is to simplify the manufacture of the tyre or tyres having the constraint of arrangement of the above-described azimuths.

To this end, the subject of the invention is a pair of a first tyre and a second tyre,
the first tyre comprising a first tread comprising cuts comprising a first cut made in a first circumferential rib delimited by first and second circumferential cuts axially adjacent to the first circumferential rib,
the second tyre comprising a second tread comprising cuts comprising a second cut made in a second circumferential rib delimited by first and second circumferential cuts axially adjacent to the second circumferential rib,
the cuts made in each first and second circumferential rib opening into each of the first and second circumferential cuts delimiting said first or second circumferential rib respectively in first and second opening zones, the azimuth of a point of the first opening zone of a cut made in said first or second circumferential rib being substantially aligned circumferentially with the azimuth of a point of the second opening zone of another cut made in said first or second circumferential rib,
each first and second cut comprising first, second and third portions, the first portion and the second portion of each first and second cut being joined directly together by a first inflection zone, the second portion and the third portion of each first and second cut being joined directly together by a second inflection zone, the second portion of each first and second cut being arranged axially between the first and third portions respectively of each first and second cut,
the mean direction of the first portion of each first and second cut not being parallel to the mean direction of the second portion respectively of each first and second cut,
the mean direction of the third portion of each first and second cut not being parallel to the mean direction of the second portion respectively of each first and second cut,
the first cut having a length along the axial direction that is different from the length along the axial direction of the second cut,
an angle formed by the mean direction of the first portion and the mean direction of the second portion of the first cut being substantially equal to an angle formed by the mean direction of the first portion and the mean direction of the second portion of the second cut,
an angle formed by the mean direction of the second portion and the mean direction of the third portion of the first cut being substantially equal to an angle formed by the mean direction of the second portion and the mean direction of the third portion of the second cut,
the length of the second portion of the first cut being substantially equal to the length of the second portion of the second cut, and
the second portion of the first cut extending along a mean direction that is not parallel to the mean direction along which the second portion of the second cut extends, and/or the length of the first portion of the first cut being different from the length of the first portion of the second cut and/or the length of the third portion of the first cut being different from the length of the third portion of the second cut.

Another subject of the invention is a tyre comprising a tread comprising cuts comprising:
a first cut made in a first circumferential rib delimited by first and second circumferential cuts axially adjacent to the first circumferential rib,
a second cut made in a second circumferential rib delimited by first and second circumferential cuts axially adjacent to the second circumferential rib,
the cuts made in each first and second circumferential rib opening into each of the first and second circumferential cuts delimiting said first or second circumferential rib respectively in first and second opening zones, the azimuth of a point of the first opening zone of a cut made in said first or second circumferential rib being substantially aligned circumferentially with the azimuth of a point of the second opening zone of another cut made in said first or second circumferential rib,
each first and second cut comprising first, second and third portions, the first portion and the second portion of each first and second cut being joined directly together by a first inflection zone, the second portion and the third portion of each first and second cut being joined directly together by a second inflection zone, the second portion of each first and second cut being arranged axially between the first and third portions respectively of each first and second cut,
the mean direction of the first portion of each first and second cut not being parallel to the mean direction of the second portion respectively of each first and second cut,
the mean direction of the third portion of each first and second cut not being parallel to the mean direction of the second portion respectively of each first and second cut,
the first cut having a length along the axial direction that is different from the length along the axial direction of the second cut,
wherein, in said tyre, an angle formed by the mean direction of the first portion and the mean direction of the second portion of the first cut is substantially equal to an angle formed by the mean direction of the first portion and the mean direction of the second portion of the second cut,
an angle formed by the mean direction of the second portion and the mean direction of the third portion of the first cut being substantially equal to an angle formed by the mean direction of the second portion and the mean direction of the third portion of the second cut,
the length of the second portion of the first cut being substantially equal to the length of the second portion of the second cut, and
the second portion of the first cut extending along a mean direction that is not parallel to the mean direction along which the second portion of the second cut extends, and/or the length of the first portion of the first cut being different from the length of the first portion of the second cut and/or the length of the third portion of the first cut being different from the length of the third portion of the second cut.

Whether relating to the pair of first and second tyres or to the single tyre, the invention makes it possible to simplify the manufacture of the moulding elements for the cuts while complying with the constraint of arrangement of the azimuths. Specifically, since the angles between the first and second portions and between the second and third portions of each first and second cut are equal, a single pressing tool is sufficient to manufacture two different moulding elements, i.e., in this case, ones having different lengths along the axial direction and making it possible to mould the first and second cuts.

In order to modify the length along the axial length of the first and second cuts without modifying the angle formed by the mean directions of the different portions with respect to one another, the direction along which the second portions extend and/or the lengths or one of the lengths of the first or third portions of the first and second cuts are differentiated while keeping the length of the second portion between the first and second cuts the same. Preferably, both the direction along which the second portions extend and the lengths of the first and/or third portions of the first and second cuts are differentiated.

Unlike a cut made up of two portions wherein the inflection zone of the first cut is necessarily axially offset with respect to the inflection zone of the second cut, it is possible in this case to centre the cut with respect to the second portion and therefore to axially position each first and second inflection zone symmetrically with respect to the middle of each cut, thereby making it possible to simplify the tooling for manufacturing the moulding elements.

The expression “directly joined together by an inflection zone” means that no other portion of said cut is interposed axially between the two portions in question. The inflection zone embodies the change in curvature of the cut between the portions in question. It will also be understood that said cut is not interrupted between the portions in question.

The inflection zone comprises an inflection point that is situated on the neutral axis of each cut and corresponds to the point at which the neutral axis undergoes a change in direction of curvature on passing from the first portion to the second portion and vice versa.

Each first, second and possible other portion may be straight or curved.

In the case of a straight portion, the determination of the mean direction is obvious.

In the case of a curved portion, the mean direction of said portion is the direction along which a straight line joining the two ends of said portion that are situated on the neutral axis extends. Since the first and second portions are joined directly together by the above-described inflection zone, the mean direction of the first portion extends along the direction of a straight line passing through one end of the first portion and the inflection point coincident with the other end of the first portion. The mean direction of the second portion extends along the direction of a straight line passing through one end of the second portion and the inflection point coincident with the other end of the second portion. The mean direction of the third portion extends along the direction of a straight line passing through one end of the third portion and the inflection point coincident with the other end of the third portion.

The length along the axial direction of said cut is equal to the distance along the circumferential direction between the two farthest-apart points of said cut along the axial direction.

Since the mean direction of the first portion and the mean direction of the second portion are not collinear, the junction between the first portion and the second portion forms an inflection point. The junction may be angular or rounded.

Two mean directions are substantially parallel if the angle formed by the two mean directions is less than or equal to 5°, preferably less than or equal to 2°.

Analogously, an angle is substantially equal to another angle if the difference between the two angles is less than or equal to 5°, preferably less than or equal to 2°.

Conversely, a mean direction is not parallel to another mean direction if the angle formed by the two mean directions is strictly greater than 5°, preferably strictly greater than 2°.

The angle formed by two mean directions is considered to be the smallest angle between these two mean directions.

The length of a portion is the length measured along the mean direction along which said portion extends. Thus, in the case of a straight portion, the length is the distance measured between the two ends of said portion. In the case of a curved portion, the length is the distance measured along the straight line joining the two ends of said portion.

The expression “substantially aligned” means that the azimuths are circumferentially distant from one another by at most 5% of the mean distance separating the two cuts made in said circumferential rib.

A cut has, on the tread surface, two main characteristic dimensions: a width and a curved length such that the curved length is at least equal to twice the width. A cut is therefore delimited by at least two main lateral faces that determine its curved length and are connected by a bottom, the two main lateral faces being distant from one another by a non-zero distance referred to as the width of the cut.

On a new tyre, the width of a cut is the maximum distance between the two main lateral faces that is measured, by default and when the cut is not chamfered, at a radial dimension coincident with the tread surface and, by default and when the cut is chamfered, at the radially outermost radial dimension of the cut that is radially inside the chamfer. The width is measured substantially perpendicularly to the main lateral faces. If a width other than the default width is specified, for example a width at a particular dimension, the width is equal to the smallest distance between the two main lateral faces at the particular dimension of the cut.

On a new tyre, the depth of a cut is the maximum radial distance between the bottom of the cut and its projection onto the ground when the tyre is running. The maximum value for the depths of the cuts is referred to as the tread pattern height.

A cut can be transverse or circumferential.

A transverse cut is such that the cut extends along a mean direction that forms an angle strictly greater than 30°, preferably greater than or equal to 45° with the circumferential direction of the tyre, that is to say one that forms an angle less than or equal to 60°, preferably strictly less than 45° with the axial direction of the tyre. The mean direction is the shortest curve joining the two ends of the cut and parallel to the tread surface. A transverse cut may be continuous, i.e. not interrupted by a tread block or another cut, such that the two main lateral faces determining its length are uninterrupted along the length of the transverse cut. A transverse cut may also be discontinuous, i.e. interrupted by one or more tread blocks and/or one or more cuts, such that the two main lateral faces determining its length are interrupted by one or more tread blocks and/or one or more cuts.

A circumferential cut is such that the cut extends along a mean direction that forms an angle less than or equal to 30°, preferably less than or equal to 10° with the circumferential direction of the tyre, that is to say one that forms an angle strictly greater than 60°, preferably strictly greater than 80° with the axial direction of the tyre. The mean direction is the shortest curve joining the two ends of the cut and parallel to the tread surface. In the case of a continuous circumferential cut, the two ends are coincident with one another and are joined by a curve that makes a full circuit around the tyre. A circumferential cut may be continuous, i.e. not interrupted by a tread block or another cut, such that the two main lateral faces determining its length are uninterrupted over a full circuit around the tyre. A circumferential cut may also be discontinuous, i.e. interrupted by one or more tread blocks and/or one or more cuts, such that the two main lateral faces determining its length are interrupted by one or more tread blocks and/or one or more cuts over a full circuit around the tyre.

In the case of a transverse cut, the lateral faces are referred to as the leading face and trailing face, and are each provided respectively with a leading edge and a trailing edge, the leading edge being the edge which, for a given circumferential line, enters the contact patch before the trailing edge.

In embodiments for optionally improving the braking on dry ground, the or each transverse cut is chamfered. A chamfer of a transverse cut can be a straight chamfer or a rounded chamfer. A straight chamfer is formed by a planar face that is inclined with respect to the leading or trailing face that it continues as far as the leading or trailing edge circumferentially delimiting the transverse cut. A rounded chamfer is formed by a curved face that merges tangentially into the leading or trailing face that it continues. A chamfer of a transverse cut is characterized by a height and a width that are equal respectively to the radial distance and to the distance along a direction perpendicular to the leading or trailing faces between the common point shared by the leading or trailing face continued by the chamfer, and the leading or trailing edge circumferentially delimiting the transverse cut.

In some embodiments for optionally improving the braking on dry ground and also the transverse grip on dry ground, at least one of the circumferential cuts is chamfered. A chamfer of a circumferential cut may be a straight chamfer or a rounded chamfer. A straight chamfer is formed by a planar face that is inclined with respect to the axially inner and outer face that it continues as far as the axially inner or outer edge axially delimiting the circumferential cut. A rounded chamfer is formed by a curved face that merges tangentially into the axially inner or outer face that it continues. A chamfer of a circumferential cut is characterized by a height and a width that are equal respectively to the radial distance and to the axial distance between the common point shared by the axially inner or outer face continued by the chamfer, and the axially inner or outer edge axially delimiting the circumferential cut.

A circumferential rib is a rib axially delimited by first and second axially adjacent circumferential cuts.

The tyre according to the invention has a substantially toric shape about an axis of revolution substantially coincident with the axis of rotation of the tyre. This axis of revolution defines three directions conventionally used by those skilled in the art: an axial direction, a circumferential direction and a radial direction.

The expression “axial direction” means the direction substantially parallel to the axis of revolution of the tyre, that is to say the axis of rotation of the tyre.

The expression “circumferential direction” means the direction which, in each meridian plane, is substantially perpendicular both to the axial direction and to a radius of the tyre (in other words, tangent to a circle centred on the axis of rotation of the tyre).

The expression “radial direction” means the direction along a radius of the tyre, that is to say any direction that intersects the axis of rotation of the tyre and is substantially perpendicular to this axis.

The expression “median plane of the tyre” (denoted M) means the plane perpendicular to the axis of rotation of the tyre, which is situated axially mid-way between the two beads and passes through the axial middle of the crown reinforcement.

The expression “equatorial circumferential plane of the tyre” (denoted E) means, in a meridian section plane, the plane passing through the equator of the tyre, perpendicular to the median plane and to the radial direction. The equator of the tyre is, in a meridian section plane (plane perpendicular to the circumferential direction and parallel to the radial and axial directions), the axis parallel to the axis of rotation of the tyre and situated equidistantly between the radially outermost point of the tread that is intended to be in contact with the ground, and the radially innermost point of the tyre that is intended to be in contact with a support, for example a rim, the distance between these two points being equal to H.

The expression “meridian plane” means a plane that is parallel to and contains the axis of rotation of the tyre and is perpendicular to the circumferential direction.

The expressions “radially inner/inside” and “radially outer/outside” mean closer to the axis of rotation of the tyre and further away from the axis of rotation of the tyre, respectively. The expressions “axially inner/inside” and “axially outer/outside” mean closer to the median plane of the tyre and further away from the median plane of the tyre, respectively.

A bead is understood to be the portion of the tyre intended to allow the tyre to be attached to a mounting support, for example a wheel comprising a rim. Thus, each bead is notably intended to be in contact with a flange of the rim allowing it to be attached.

Any range of values denoted by the expression “between a and b” represents the range of values ranging from more than a to less than b (i.e. excluding the limits a and b), whereas any range of values denoted by the expression “from a to b” means the range of values ranging from a to b (i.e. including the strict limits a and b).

In preferred embodiments of the invention, the tyres are intended for passenger vehicles as defined in accordance with the European Tyre and Rim Technical Organisation, or “ETRTO”, standard of 2021. Such a tyre has a section in a meridian section plane that is characterized by a section height H and a nominal section width S within the meaning of the European Tyre and Rim Technical Organisation, or “ETRTO”, standard of 2021, such that the ratio H/S, expressed as a percentage, is at most equal to 90 and is at least equal to 20, and the nominal section width S is at least equal to 115 mm, preferably at least equal to 175 mm and at most equal to 385 mm, preferably at most equal to 315 mm. Moreover, the diameter at the flange D, defining the diameter of the mounting rim of the tyre, is at least equal to 15 inches and at most equal to 24 inches.

In preferred embodiments of the invention, the tyres are “summer” tyres. Summer tyres are understood to be tyres that are not “4-season” or “all-season” tyres, or “winter” tyres.

Winter tyres are in particular identified by an M+S marking (M+S being short for “Mud+Snow”) and/or a 3PMSF marking (3PMSF being short for “3 Peak Mountain Snow Flake”). 4-season or all-season tyres also have M+S and/or 3PMSF markings on account of their performance on snow. Thus, a summer tyre does not have an M+S marking or a 3PMSF marking.

In preferred embodiments, irrespective of the subject of the invention, the cuts that comply with the azimuth constraint are circumferentially adjacent.

In preferred embodiments, irrespective of the subject of the invention, each first and second circumferential rib has a substantially constant width.

Optionally, when the subject of the invention is a pair of first and second tyres, the first and second tyres have:
markings indicating the same trade name, and/or
markings indicating the same model.

Optionally, when the subject of the invention is a pair of first and second tyres, the first cut has a length along the axial direction that is different from the length along the axial direction of the second cut, since:
the first tyre has a nominal section width that is different from the nominal section width of the second tyre, and/or
the first circumferential rib has an axial length that is different from the axial length of the second circumferential rib.

Thus, for example, when the first cut has a length along the axial direction that is strictly less than the length along the axial direction of the second cut:
the first tyre has a nominal section width that is strictly less than the nominal section width of the second tyre, and/or
the first circumferential rib has an axial length that is strictly less than the axial length of the second circumferential rib.

Optionally, each cut has a width ranging from 0.2 mm to 3.0 mm, preferably from 0.4 mm to 2.0 mm, preferably from 0.4 mm to 1.0 mm.

Optionally, each cut has a depth ranging from 2.0 mm to the tread pattern height, preferably ranging from 4.0 mm to the tread pattern height, and more preferably ranging from 5.0 mm to the tread pattern height.

In optional embodiments, the first cut has a length along the circumferential direction that is substantially equal to the length along the circumferential direction of the second cut. Thus, the first and second cuts can be used for tyres or ribs having different lengths along the axial direction without regard to their lengths in the circumferential direction, which are substantially equal.

The length along the circumferential direction of said cut is equal to the distance along the circumferential direction between the two farthest-apart points of said cut along the circumferential direction.

In some embodiments, in which the second portion of the first cut extends along a mean direction that is not parallel to the mean direction along which the second portion of the second cut extends:
the first portion of the first cut extends along a mean direction that is not parallel to the mean direction along which the first portion of the second cut extends, and
the third portion of the first cut extends along a mean direction that is not parallel to the mean direction along which the third portion of the second cut extends.

In embodiments in which the length of the first portion of the first cut is different from the length of the first portion of the second cut and/or the length of the third portion of the first cut is different from the length of the third portion of the second cut, and, for example, when the first cut has a length along the axial direction that is strictly less than the length along the axial direction of the second cut:
the length of the first portion of the first cut is strictly less than the length of the first portion of the second cut, and/or
the length of the third portion of the first cut is strictly less than the length of the third portion of the second cut.

Preferably, each first and second cut is made up of the first, second and third portions. In other words, with each cut comprising two ends, one end of the first portion is coincident with one of the ends of said cut and one end of the third portion is coincident with the other of the ends of said cut.

In advantageous but optional variants, in order to reduce the number of pressing tools necessary for manufacturing the moulding elements of the cuts comprising first, second and third portions, an angle formed by the mean direction of the first portion and the mean direction of the second portion of each first and second cut is substantially equal to an angle formed by the mean direction of the second portion and the mean direction of the third portion of each first and second cut. Thus, in other words, the mean direction of the third portion is substantially parallel to the mean direction of the first portion.

In other less advantageous and optional variants, an angle formed by the mean direction of the first portion and the mean direction of the second portion of each first and second cut is different from an angle formed by the mean direction of the second portion and the mean direction of the third portion of each first and second cut. Thus, in other words, the mean direction of the third portion is not parallel to the mean direction of the first portion.

In a more preferred manner making it possible to simplify the design of the pressing tools:
the length of the first portion of the first cut is equal to the length of the third portion of the first cut, and/or
the length of the first portion of the second cut is equal to the length of the third portion of the second cut.

Optionally, in order to limit whining, the cuts comprise a third cut made in a third circumferential rib delimited by first and second circumferential cuts axially adjacent to the third circumferential rib,
the cuts made in the third circumferential rib opening into each of the first and second circumferential cuts delimiting said third circumferential rib respectively in first and second opening zones, the azimuth of a point of the first opening zone of a cut made in said third circumferential rib being substantially aligned circumferentially with the azimuth of a point of the second opening zone of another cut made in said third circumferential rib,
the third cut comprising first, second and third portions, the first portion and the second portion of the third cut being joined directly together by a first inflection zone, the second portion and the third portion of the third cut being joined directly together by a second inflection zone, the second portion of the third cut being arranged axially between the first and third portions of the third cut,
the mean direction of the first portion of the third cut not being parallel to the mean direction of the second portion of the third cut,
the mean direction of the third portion of the third cut not being parallel to the mean direction of the second portion respectively of the third cut,
the third cut having a length along the axial direction that is different from the length along the axial direction of each first and second cut,
an angle formed by the mean direction of the first portion and the mean direction of the second portion of the third cut being substantially equal to an angle formed by the mean direction of the first portion and the mean direction of the second portion of each first and second cut,
an angle formed by the mean direction of the second portion and the mean direction of the third portion of the third cut being substantially equal to an angle formed by the mean direction of the second portion and the mean direction of the third portion of each first and second cut,
the length of the second portion of the third cut being substantially equal to the length of the second portion of each first and second cut,
the second portion of the third cut extending along a mean direction that is not parallel to the mean direction along which the second portion of each first and second cut extends, and/or the length of the first portion of the third cut being different from the length of the first portion of each first and second cut and/or the length of the third portion of the third cut being different from the length of the third portion of each first and second cut.

In preferred embodiments, the third circumferential rib has a substantially constant width.

In optional embodiments, the third cut has a length along the circumferential direction that is substantially equal to the length along the circumferential direction of each first and second cut.

In some embodiments, in which the second portion of the third cut extends along a mean direction that is not parallel to the mean direction along which the second portion of each first and second cut extends:
the first portion of the third cut extends along a mean direction that is not parallel to the mean direction of the first portion of each first and second cut, and
the third portion of the third cut extends along a mean direction that is not parallel to the mean direction of the third portion of each first and second cut.

In embodiments in which the length of the first portion of the third cut is different from the length of the third portion of each first and second cut and/or the length of the third portion of the third cut is different from the length of the third portion of each first and second cut, and, for example, when the first cut has a length along the axial direction that is strictly less than the length along the axial direction of the second cut and the second cut has a length along the axial direction that is strictly less than the length along the axial direction of the third cut:
the length of the first portion of the first cut is strictly less than the length of the first portion of the second cut and the length of the first portion of the second cut is strictly less than the length of the first portion of the third cut, and/or
the length of the third portion of the first cut is strictly less than the length of the third portion of the second cut and the length of the third portion of the second cut is strictly less than the length of the third portion of the third cut.

Preferably, the third cut is made up of the first, second and third portions.

In advantageous but optional variants that make it possible to reduce the number of pressing tools necessary for manufacturing the moulding elements of the cuts, an angle formed by the mean direction of the first portion and the mean direction of the second portion of the third cut is substantially equal to an angle formed by the mean direction of the second portion and the mean direction of the third portion of the third cut.

In other less advantageous and optional variants, an angle formed by the mean direction of the first portion and the mean direction of the second portion of the third cut is different from an angle formed by the mean direction of the second portion and the mean direction of the third portion of the third cut.

In an even more preferred manner making it possible to simplify the design of the pressing tools, the length of the first portion of the third cut is equal to the length of the third portion of the third cut.

Optionally and preferably, each first and second circumferential cut has a depth greater than or equal to 50%, preferably greater than or equal to 75%, and more preferably greater than or equal to 90%, of the tread pattern height.

Optionally and preferably, each first and second circumferential cut has a depth ranging from 4.0 mm to the tread pattern height, preferably ranging from 5.0 mm to the tread pattern height, and more preferably ranging from 5.5 mm to the tread pattern height.

Optionally and preferably, each first and second circumferential cut has a width greater than or equal to 1.0 mm, preferably greater than or equal to 4.0 mm, and more preferably ranging from 4.0 mm to 20.0 mm.

In preferred embodiments, each cut has a mean direction forming an angle greater than or equal to 45° with the circumferential direction of the tyre. The mean direction of the cut is the direction along which the straight line joining the two ends of the cut extends.

Conventionally, the or each tyre comprises a crown, two sidewalls and two beads, each sidewall connecting each bead to the crown. Still conventionally, the crown comprises the tread and a crown reinforcement arranged radially on the inside of the tread. The or each tyre also comprises a carcass reinforcement that is anchored in each bead and extends radially in each sidewall and axially in the crown, radially on the inside of the crown reinforcement.

Conventionally, the crown reinforcement comprises at least one crown layer comprising reinforcing elements. These reinforcing elements are preferably textile or metal filamentary elements.

In embodiments that make it possible to obtain performance aspects of tyres referred to as radial tyres as defined by the ETRTO, the carcass reinforcement comprises at least one carcass layer, the or each carcass layer comprising carcass filamentary reinforcing elements, each carcass filamentary reinforcing element extending substantially along a main direction forming an angle with the circumferential direction of the tyre that ranges, in terms of absolute value, from 80° to 90°.

The invention will be understood better on reading the following description, which is provided purely by way of non-limiting example, with reference to the drawings, in which:

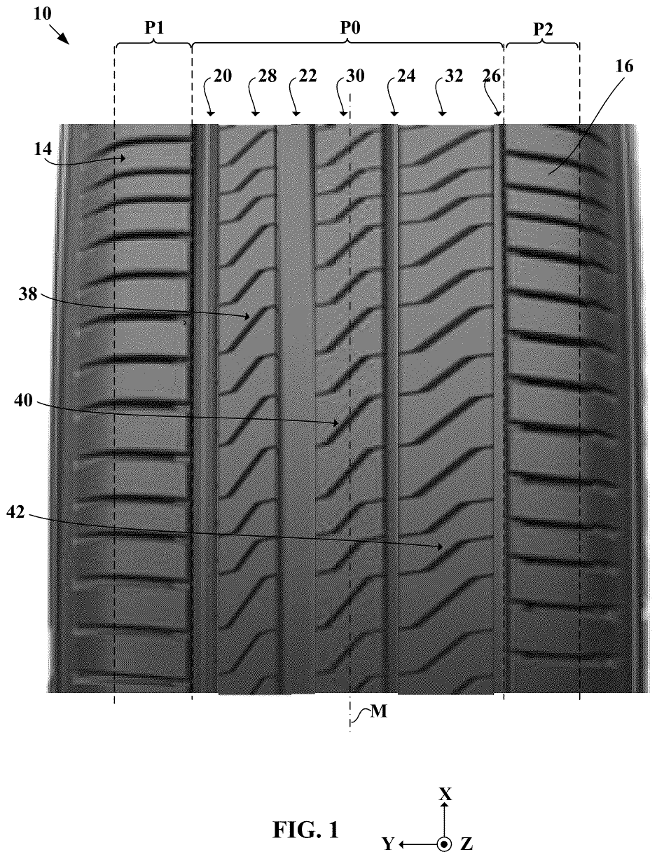

FIG. 1 is a top view of a tread of a tyre according to a first embodiment of the invention,

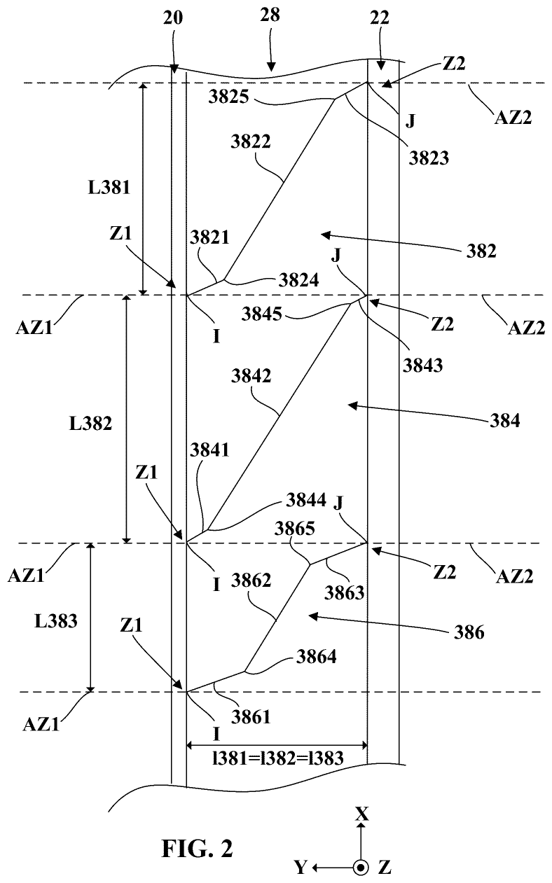

FIGS. 2 to 5 are schematic views of a part of the tread of the tyre in FIG. 1, illustrating cuts made in a first circumferential rib,

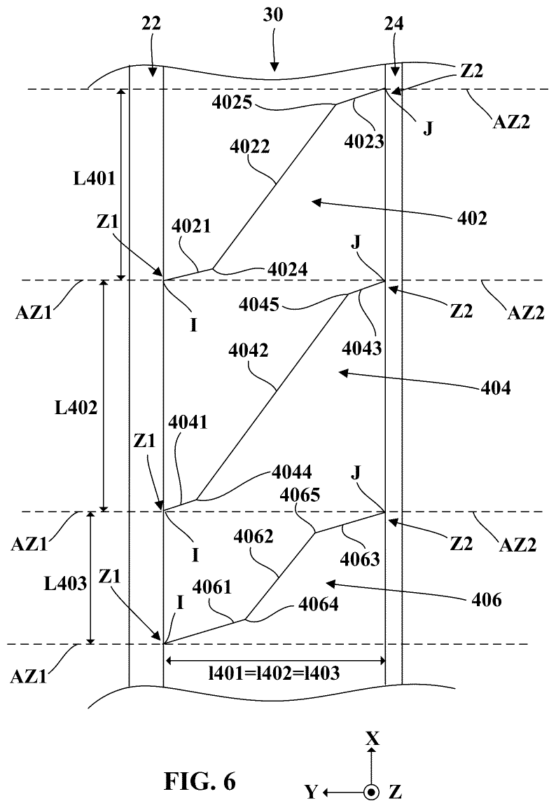

FIGS. 6 to 9 are schematic views similar to those in FIGS. 2 to 5, illustrating cuts made in a second circumferential rib,

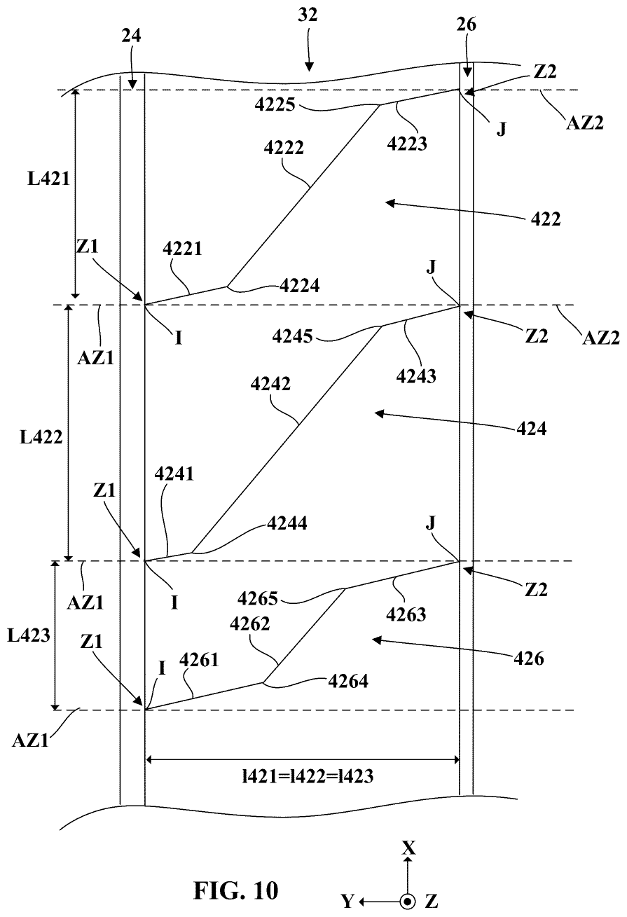

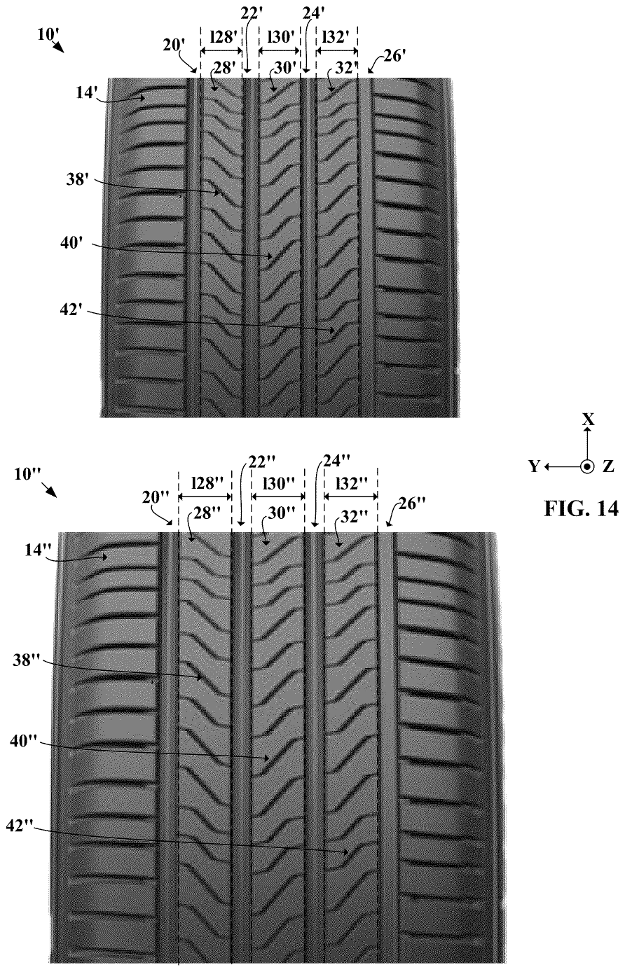

FIGS. 10 to 13 are schematic views similar to those in FIGS. 2 to 5, illustrating cuts made in a third circumferential rib, and

FIG. 14 is a top view of the treads of a pair of a first and a second tyre according to the invention.

A frame of reference X, Y, Z corresponding to the usual axial (Y), radial (Z) and circumferential (X) directions, respectively, of a tyre is shown.

With reference to FIG. 1, the tyre according to the invention is denoted by the general reference 10. The tyre 10 has a substantially toric shape about an axis of revolution substantially parallel to the axial direction Y. The tyre 10 is intended for a passenger vehicle and is of the size 205/55R16. The tyre 10 is a summer tyre. The tyre 10 is shown as new, i.e. when it has not yet been run.

The tyre 10 comprises a tread 14 intended to come into contact with the ground during running. The tyre 10 also comprises a conventional structure, as described, for example, in applications WO2021250331, WO2022074341 or WO2022069819. The tyre 10 is obtained by moulding a green tyre in a mould comprising moulding elements, in particular moulding elements for the tread 14.

The tread 14 comprises a tread surface 16 via which the tread 14 is intended to come into contact with the ground when the tyre 10 is running on the ground.

The tread 14 comprises an axially central portion P0and first and second axially lateral portions P1, P2 arranged axially on the outside of the axially central portion P0and axially on either side of the axially central portion P0with respect to the median plane M of the tyre 10.

The tread 14 comprises N>1 circumferential cuts, in this case N=4 circumferential cuts denoted by the references 20, 22, 24, 26. Each circumferential cut 20 to 26 has a depth ranging from 4.0 mm to the tread pattern height Hs, preferably ranging from 5.0 mm to the tread pattern height Hs and more preferably ranging from 5.5 mm to the tread pattern height Hs. Each depth is greater than or equal to 50%, preferably 75% and more preferably greater than or equal to 90% of the tread pattern height. In this case, Hs=7.2 mm, the depth of each circumferential cut 20, 26 being equal to 7.0 mm and the depth of each circumferential cut 22, 24 being equal to 7.2 mm.

Each circumferential cut 20 to 26 has a width greater than or equal to 1.0 mm, preferably greater than or equal to 4.0 mm and more preferably ranging from 4.0 mm to 20.0 mm. In this case, the width of each circumferential cut 20, 22, 24, 26 is respectively equal to 11.0 mm, 18.0 mm, 7.0 mm and 3.0 mm.

The axially central portion P0comprises k≥1 circumferential ribs, in this case k=3 first, second and third circumferential ribs 28, 30, 32. Each first, second and third circumferential rib 28 to 32 is axially delimited by first and second axially adjacent circumferential cuts from the circumferential cuts 20 to 26. Each first, second and third circumferential rib 28 to 32 has a substantially constant length along the axial direction.

Each first, second and third circumferential rib 28, 30, 32 comprises transverse cuts made in said first, second and third central rib 28, 30, 32 and respectively denoted by the references 38, 40, 42. Thus, the cuts 38 are made in the same first circumferential rib 28, the cuts 40 are made in the same second circumferential rib 30 and the cuts 42 are made in the same third circumferential rib 32. Each cut 38 opens into each of the circumferential cuts 20, 22. Each cut 40 opens into each of the circumferential cuts 22, 24. Each cut 42 opens into each of the circumferential cuts 24, 26.

Each cut 38, 40, 42 has a mean direction forming an angle greater than or equal to 45° with the circumferential direction X of the tyre 10. Each cut 38, 40, 42 has a width ranging from 0.2 mm to 3.0 mm, preferably from 0.4 mm to 2.0 mm, more preferably from 0.4 mm to 1.0 mm and in this case equal to 0.4 mm. Each cut 38, 40, 42 has a depth ranging from 2.0 mm to the tread pattern height Hs, preferably ranging from 4.0 mm to the tread pattern height Hs and more preferably ranging from 5.0 mm to the tread pattern height Hs and in this case equal to 5.5 mm.

FIG. 2 shows first cuts 38, denoted respectively by references 382, 384 and 386, made in the first circumferential rib 28 delimited by the circumferential cuts 20, 22. The first cut 384 is circumferentially adjacent to each first cut 382, 386. Each first cut 38 comprises two ends I and J.

Each first cut 382 has a length I381 along the axial direction Y substantially equal to the length 1382 along the axial direction Y of each first cut 384 and substantially equal to the length 1383 along the axial direction Y of each first cut 386. In this case, I381=1382=1383=20 mm.

Each first cut 382 has a length L381 along the circumferential direction X that is different from the length L382 along the circumferential direction X of each first cut 384. Each first cut 384 has a length L382 along the circumferential direction X that is different from the length L383 along the circumferential direction X of each first cut 386. Each first cut 382 has a length L381 along the circumferential direction X that is different from the length L383 along the circumferential direction X of each first cut 386. In this case, L381=16.3 mm, L382=17.9 mm and L383=23.1 mm.

Each first cut 382, 384, 386 opens into each of the circumferential cuts 20, 22 respectively in first and second opening zones Z1, Z2. The azimuth AZ1 of a point of the first opening zone AZ1 of a first cut 382, 384, 386 made in the first circumferential rib 28, in this case the end I, is substantially aligned circumferentially with the azimuth AZ2 of a point of the second opening zone AZ2 of another of the first cuts 382, 384, 386 that is circumferentially adjacent and made in the first circumferential rib 28, in this case the end J of another of the first cuts 382, 384, 386 that is circumferentially adjacent and made in the first circumferential rib 28.

Each first cut 382 comprises, and in this case is made up of, first, second and third portions 3821, 3822 and 3823. Each first cut 384 comprises, and in this case is made up of, first, second and third portions 3841, 3842 and 3843. Each first cut 386 comprises, and in this case is made up of, first, second and third portions 3861, 3862 and 3863. Each second portion 3822, 3842, 3862 is arranged axially between the corresponding first portion 3821, 3841, 3861 and the corresponding third portion 3823, 3843, 3863. Each first portion 3821, 3841, 3861 and each second portion 3822, 3842, 3862 are joined directly together respectively by a first inflection zone 3824, 3844, 3864. Each second portion 3822, 3842, 3862 and each third portion 3823, 3843, 3863 are joined directly together respectively by a second inflection zone 3825, 3845, 3865.

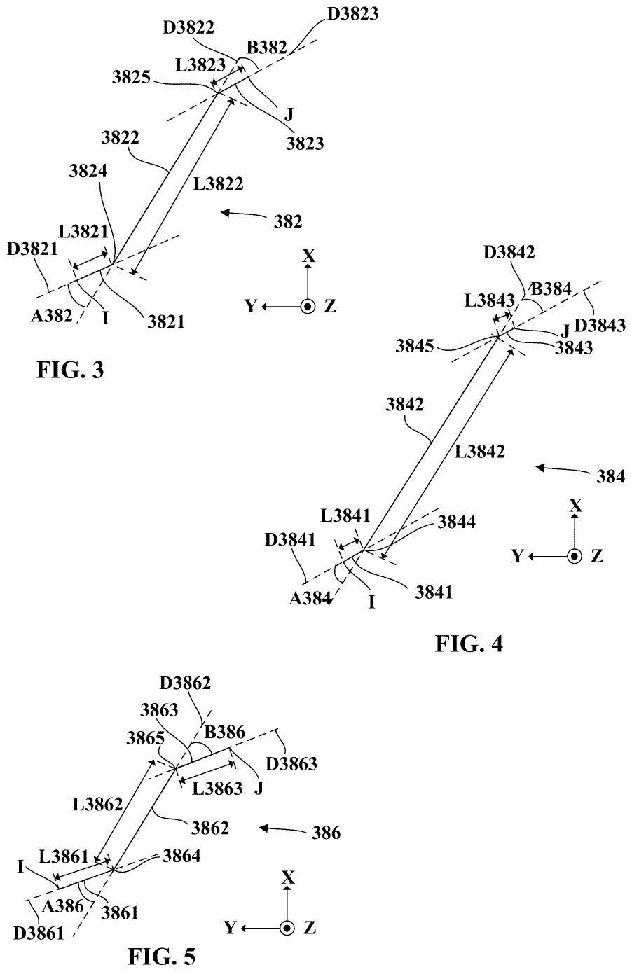

As can be seen in FIGS. 3 to 5, the length L3821 of the first portion 3821 of each first cut 382 is different from the length L3841 of the first portion 3841 of each first cut 384 and from the length L3861 of the first portion 3861 of each first cut 386. The length L3821 of the first portion 3841 of each first cut 384 is different from the length L3861 of the first portion 3861 of each first cut 386. In this case, L3821=5.83 mm, L3841=5.21 mm, L3861=3.12 mm.

The length L3822 of the second portion 3822 of each first cut 382 is different from the length L3842 of the second portion 3842 of each first cut 384 and from the length L3862 of the second portion 3862 of each first cut 386. The length L3842 of the second portion 3842 of each first cut 384 is different from the length L3862 of the second portion 3862 of each first cut 386. In this case, In this case, L382=16.11 mm, L3842=18.35 mm, L3862=25.75 mm.

The length L3823 of the third portion 3823 of each first cut 382 is different from the length L3843 of the third portion 3843 of each first cut 384 and from the length L3863 of the third portion 3863 of each first cut 386. The length L3843 of the third portion 3843 of each first cut 384 is different from the length L3863 of the third portion 3863 of each first cut 386. In this case, L3823=5.83 mm, L3843=5.21 mm, L3863=3.12 mm.

It will be noted that the length L3821 of each first portion 3821 of each first cut 382 is equal to the length L3823 of each third portion 3823 of each first cut 382. It will also be noted that the length L3841 of each first portion 3841 of each first cut 384 is equal to the length L3843 of each third portion 3843 of each first cut 384. Lastly, it will be noted that the length L3861 of each first portion 3861 of each first cut 386 is equal to the length L3863 of each third portion 3863 of each first cut 386.

Each first, second and third portion 3821, 3822, 3823 of the first cut 382 extends respectively along a first, second and third mean direction D3821, D3822, D3823. Each first, second and third portion 3841, 3842, 3843 of the first cut 384 extends respectively along a first, second and third mean direction D3841, D3842, D3843. Each first, second and third portion 3821, 3822, 3823 of the first cut 386 extends respectively along a first, second and third mean direction D3861, D3862, D3863.

The mean direction D3821, D3841, D3861 of each first portion 3821, 3841, 3861 and the mean direction D3823, D3843, D3863 of each third portion 3823, 3843, 3863 of each first cut 382, 384, 386 is not parallel to the mean direction D3822, D3842, D3862 of the second portion 3822, 3842, 3862 respectively of each first cut 382, 384, 386.

The mean directions D3821, D3841 and D3861 are substantially parallel to one another. The mean directions D3822, D3842 and D3862 are substantially parallel to one another. The mean directions D3823, D3843 and D3863 are substantially parallel to one another.

The mean direction D3821 of the first portion 3821 and the mean direction D3822 of the second portion 3822 of the first cut 382 form an angle A382. The mean direction D3841 of the first portion 3841 and the mean direction D3842 of the second portion 3842 of the first cut 384 form an angle A384. The mean direction D3861 of the first portion 3861 and the mean direction D3862 of the second portion 3862 of the first cut 386 form an angle A386.

The mean direction D3822 of the second portion 3822 and the mean direction D3823 of the third portion 3823 of the first cut 382 form an angle B382. The mean direction D3842 of the second portion 3842 and the mean direction D3843 of the third portion 3843 of the first cut 384 form an angle B384. The mean direction D3862 of the second portion 3862 and the mean direction D3863 of the third portion 3863 of the first cut 386 form an angle B386.

FIG. 6 shows second cuts 40, denoted respectively by references 402, 404 and 406, made in the second circumferential rib 30 delimited by the circumferential cuts 22, 24. The second cut 404 is circumferentially adjacent to each second cut 402, 406. Each second cut 40 comprises two ends I and J.

Each second cut 402 has a length I401 along the axial direction Y substantially equal to the length I402 along the axial direction Y of each second cut 404 and substantially equal to the length I403 along the axial direction Y of each second cut 406. In this case, I401=I402=I403=28 mm.

Each second cut 402 has a length L401 along the circumferential direction X that is different from the length L402 along the circumferential direction X of each second cut 404. Each second cut 404 has a length L402 along the circumferential direction X that is different from the length L403 along the circumferential direction X of each second cut 406. Each second cut 402 has a length L401 along the circumferential direction X that is different from the length L403 along the circumferential direction X of each second cut 406. In this case, L401=16.3 mm, L402=17.9 mm and L403=23.1 mm.

Each second cut 402, 404, 406 opens into each of the circumferential cuts 20, 22 respectively in first and second opening zones Z1, Z2. The azimuth AZ1 of a point of the first opening zone AZ1 of a second cut 402, 404, 406 made in the second circumferential rib 30, in this case the end I, is substantially aligned circumferentially with the azimuth AZ2 of a point of the second opening zone AZ2 of another of the second cuts 402, 404, 406 that is circumferentially adjacent and made in the second circumferential rib 30, in this case the end J of another of the second cuts 402, 404, 406 that is circumferentially adjacent and made in the second circumferential rib 30.

Each second cut 402 comprises, and in this case is made up of, first, second and third portions 4021, 4022 and 4023. Each second cut 404 comprises, and in this case is made up of, first, second and third portions 4041, 4042 and 4043. Each second cut 406 comprises, and in this case is made up of, first, second and third portions 4061, 4062 and 4063. Each second portion 4022, 4042, 4062 is arranged axially between the corresponding first portion 4021, 4041, 4061 and the corresponding third portion 4023, 4043, 4063. Each first portion 4021, 4041, 4061 and each second portion 4022, 4042, 4062 are joined directly together respectively by a first inflection zone 4024, 4044, 4064. Each second portion 4022, 4042, 4062 and each third portion 4023, 4043, 4063 are joined directly together respectively by a second inflection zone 4025, 4045, 4065.

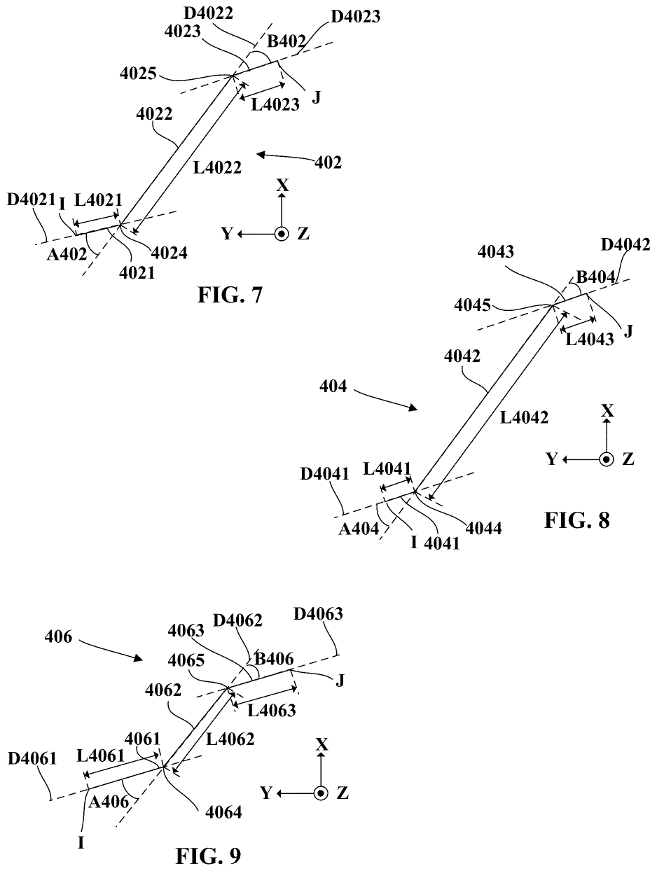

As can be seen in FIGS. 7 to 9, the length L4021 of the first portion 4021 of each second cut 402 is different from the length L4041 of the first portion 4041 of each second cut 404 and from the length L4061 of the first portion 4061 of each second cut 406. The length L4021 of the first portion 4041 of each second cut 404 is different from the length L4061 of the first portion 4061 of each second cut 406. In this case, L4021=9.41 mm, L4041=8.75 mm, L4061=6.53 mm.

The length L4022 of the second portion 4022 of each second cut 402 is different from the length L4042 of the second portion 4042 of each second cut 404 and from the length L4062 of the second portion 4062 of each second cut 406. The length L4042 of the second portion 4042 of each second cut 404 is different from the length L4062 of the second portion 4062 of each second cut 406. In this case, In this case, L4022=16.11 mm, L4042=18.35 mm, L4062=25.75 mm.

The length L4023 of the third portion 4023 of each second cut 402 is different from the length L4043 of the third portion 4043 of each second cut 404 and from the length L4063 of the third portion 4063 of each second cut 406. The length L4043 of the third portion 4043 of each second cut 404 is different from the length L4063 of the third portion 4063 of each second cut 406. In this case, L4023=9.41 mm, L4043=8.75 mm, L4063=6.53 mm.

It will be noted that the length L4021 of each first portion 4021 of each second cut 402 is equal to the length L4023 of each third portion 4023 of each second cut 402. It will also be noted that the length L4041 of each first portion 4041 of each second cut 404 is equal to the length L4043 of each third portion 4043 of each second cut 404. Lastly, it will be noted that the length L4061 of each first portion 4061 of each second cut 406 is equal to the length L4063 of each third portion 4063 of each second cut 406.

Each first, second and third portion 4021, 4022, 4023 of the second cut 402 extends respectively along a first, second and third mean direction D4021, D4022, D4023. Each first, second and third portion 4041, 4042, 4043 of the second cut 404 extends respectively along a first, second and third mean direction D4041, D4042, D4043. Each first, second and third portion 4021, 4022, 4023 of the second cut 406 extends respectively along a first, second and third mean direction D4061, D4062, D4063.

The mean direction D4021, D4041, D4061 of each first portion 4021, 4041, 4061 and the mean direction D4023, D4043, D4063 of each third portion 4023, 4043, 4063 of each second cut 402, 404, 406 is not parallel to the mean direction D4022, D4042, D4062 of the second portion 4022, 4042, 4062 respectively of each second cut 402, 404, 406.

The mean directions D4021, D4041 and D4061 are substantially parallel to one another. The mean directions D4022, D4042 and D4062 are substantially parallel to one another. The mean directions D4023, D4043 and D4063 are substantially parallel to one another.

The mean direction D4021 of the first portion 4021 and the mean direction D4022 of the second portion 4022 of the second cut 402 form an angle A402. The mean direction D4041 of the first portion 4041 and the mean direction D4042 of the second portion 4042 of the second cut 404 form an angle A404. The mean direction D4061 of the first portion 4061 and the mean direction D4062 of the second portion 4062 of the second cut 406 form an angle A406.

The mean direction D4022 of the second portion 4022 and the mean direction D4023 of the third portion 4023 of the second cut 402 form an angle B402. The mean direction D4042 of the second portion 4042 and the mean direction D4043 of the third portion 4043 of the second cut 404 form an angle B404. The mean direction D4062 of the second portion 4062 and the mean direction D4063 of the third portion 4063 of the second cut 406 form an angle B406.

FIG. 10 shows third cuts 42, denoted respectively by references 422, 424 and 426, made in the third circumferential rib 32 delimited by the circumferential cuts 22, 24. The third cut 424 is circumferentially adjacent to each third cut 422, 426. Each third cut 42 comprises two ends I and J.

Each third cut 422 has a length I421 along the axial direction Y substantially equal to the length I422 along the axial direction Y of each third cut 424 and substantially equal to the length I423 along the axial direction Y of each third cut 426. In this case, I421=I422=I423=35 mm.

Each third cut 422 has a length L421 along the circumferential direction X that is different from the length L422 along the circumferential direction X of each third cut 424. Each third cut 424 has a length L422 along the circumferential direction X that is different from the length L423 along the circumferential direction X of each third cut 426. Each third cut 422 has a length L421 along the circumferential direction X that is different from the length L423 along the circumferential direction X of each third cut 426. In this case, L421=16.3 mm, L422=17.9 mm and L423=23.1 mm.

Each third cut 422, 424, 426 opens into each of the circumferential cuts 20, 22 respectively in first and second opening zones Z1, Z2. The azimuth AZ1 of a point of the first opening zone AZ1 of a second cut 422, 424, 426 made in the third circumferential rib 32, in this case the end I, is substantially aligned circumferentially with the azimuth AZ2 of a point of the second opening zone AZ2 of another of the third cuts 422, 424, 426 that is circumferentially adjacent and made in the third circumferential rib 32, in this case the end J of another of the third cuts 422, 424, 426 that is circumferentially adjacent and made in the third circumferential rib 32.

Each third cut 422 comprises, and in this case is made up of, first, second and third portions 4221, 4222 and 4223. Each third cut 424 comprises, and in this case is made up of, first, second and third portions 4241, 4242 and 4243. Each third cut 426 comprises, and in this case is made up of, first, second and third portions 4261, 4262 and 4263. Each second portion 4222, 4242, 4262 is arranged axially between the corresponding first portion 4221, 4241, 4261 and the corresponding third portion 4223, 4243, 4263. Each first portion 4221, 4241, 4261 and each second portion 4222, 4242, 4262 are joined directly together respectively by a first inflection zone 4224, 4244, 4264. Each second portion 4222, 4242, 4262 and each third portion 4223, 4243, 4263 are joined directly together respectively by a second inflection zone 4225, 4245, 4265.

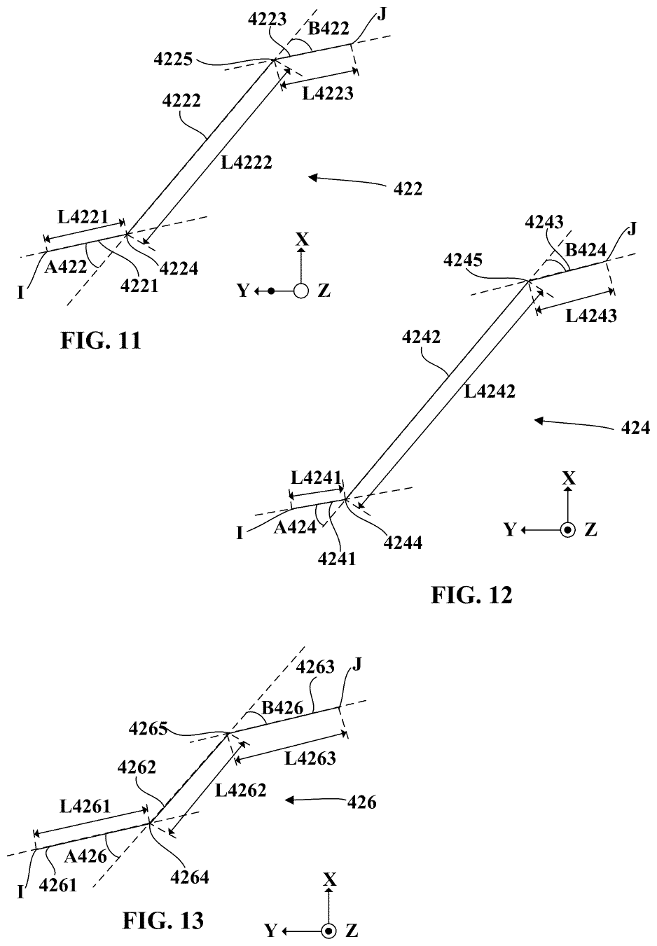

As can be seen in FIGS. 11 to 13, the length L4221 of the first portion 4221 of each third cut 422 is different from the length L4241 of the first portion 4241 of each third cut 424 and from the length L4261 of the first portion 4261 of each third cut 426. The length L4221 of the first portion 4241 of each third cut 424 is different from the length L4261 of the first portion 4261 of each third cut 426. In this case, L4221=12.68 mm, L4241=12.00 mm, L4261=9.71 mm.

The length L4222 of the second portion 4222 of each third cut 422 is different from the length L4242 of the second portion 4242 of each third cut 424 and from the length L4262 of the second portion 4262 of each third cut 426. The length L4242 of the second portion 4242 of each third cut 424 is different from the length L4262 of the second portion 4262 of each third cut 426. In this case, In this case, L4222=16.11 mm, L4242=18.35 mm, L4262=25.75 mm.

The length L4223 of the third portion 4223 of each third cut 422 is different from the length L4243 of the third portion 4243 of each third cut 424 and from the length L4263 of the third portion 4263 of each third cut 426. The length L4243 of the third portion 4243 of each third cut 424 is different from the length L4263 of the third portion 4263 of each third cut 426. In this case, L4223=12.68 mm, L4243=12.00 mm, L4263=9.71 mm.

It will be noted that the length L4221 of each first portion 4221 of each third cut 422 is equal to the length L4223 of each third portion 4223 of each third cut 422. It will also be noted that the length L4241 of each first portion 4241 of each third cut 424 is equal to the length L4243 of each third portion 4243 of each third cut 424. Lastly, it will be noted that the length L4261 of each first portion 4261 of each third cut 426 is equal to the length L4263 of each third portion 4263 of each third cut 426.

Each first, second and third portion 4221, 4222, 4223 of the third cut 422 extends respectively along a first, second and third mean direction D4221, D4222, D4223. Each first, second and third portion 4241, 4242, 4243 of the third cut 424 extends respectively along a first, second and third mean direction D4241, D4242, D4243. Each first, second and third portion 4221, 4222, 4223 of the third cut 426 extends respectively along a first, second and third mean direction D4261, D4262, D4263.

The mean direction D4221, D4241, D4261 of each first portion 4221, 4241, 4261 and the mean direction D4223, D4243, D4263 of each third portion 4223, 4243, 4263 of each third cut 422, 424, 426 is not parallel to the mean direction D4222, D4242, D4262 of the second portion 4222, 4242, 4262 respectively of each third cut 422, 424, 426.

The mean directions D4221, D4241 and D4261 are substantially parallel to one another. The mean directions D4222, D4242 and D4262 are substantially parallel to one another. The mean directions D4223, D4243 and D4263 are substantially parallel to one another.

The mean direction D4221 of the first portion 4221 and the mean direction D4222 of the second portion 4222 of the third cut 422 form an angle A422. The mean direction D4241 of the first portion 4241 and the mean direction D4242 of the second portion 4242 of the third cut 424 form an angle A424. The mean direction D4261 of the first portion 4261 and the mean direction D4262 of the second portion 4262 of the third cut 426 form an angle A426.

The mean direction D4222 of the second portion 4222 and the mean direction D4223 of the third portion 4223 of the third cut 422 form an angle B422. The mean direction D4242 of the second portion 4242 and the mean direction D4243 of the third portion 4243 of the third cut 424 form an angle B424. The mean direction D4262 of the second portion 4262 and the mean direction D4263 of the third portion 4263 of the third cut 426 form an angle B426.

With reference to all of FIGS. 1 to 13, each first cut 382, 384, 386 has a length I381, 1382, 1383 along the axial direction Y that is different from the length I401, I402, I403 along the axial direction Y of each second cut 402, 404, 406. Each first cut 382, 384, 386 has a length I381, 1382, 1383 along the axial direction Y that is different from the length I421, I422, I423 along the axial direction Y of each third cut 422, 424, 426. Each second cut 402, 404, 406 has a length I401, I402, I403 along the axial direction Y that is different from the length I421, I422, I423 along the axial direction Y of each third cut 422, 424, 426. In this case, I381=1382=1383<I401=I402=I403 <I421=I422=I423.

Each first cut 382, 384, 386 has a length L381, L382, L383 along the circumferential direction X substantially equal to the length L401, L402, L403 along the circumferential direction X respectively of each second cut 402, 404, 406 and substantially equal to the length L421, L422, L423 along the circumferential direction X respectively of each third cut 422, 424, 426.

The length L3821, L3841, L3861 of the first portion 3821, 3841, 3861 of each first cut 382, 384, 386 is respectively different from, and in this case strictly less than the length L4021, L4041, L4061 of the first portion 4021, 4041, 4061 of each second cut 402, 404, 406. The length L3821, L3841, L3861 of the first portion 3821, 3841, 3861 of each first cut 382, 384, 386 is respectively different from, and in this case strictly less than the length L4221, L4241, L4261 of the first portion 4221, 4241, 4261 of each third cut 402, 404, 406. The length L4021, L4041, L4061 of the first portion 4021, 4041, 4061 of each second cut 402, 404, 406 is respectively different from, and in this case strictly less than the length L4221, L4241, L4261 of the first portion 4221, 4241, 4261 of each third cut 402, 404, 406.

The length L3822, L3842, L3862 of the second portion 3822, 3842, 3862 of each first cut 382, 384, 386 is respectively substantially equal to the length L4022, L4042, L4062 of the second portion 4022, 4042, 4062 of each second cut 402, 404, 406. The length L3822, L3842, L3862 of the second portion 3822, 3842, 3862 of each first cut 382, 384, 386 is respectively substantially equal to the length L4222, L4242, L4262 of the second portion 4222, 4242, 4262 of each third cut 402, 404, 406. The length L4022, L4042, L4062 of the second portion 4022, 4042, 4062 of each second cut 402, 404, 406 is respectively substantially equal to the length L4222, L4242, L4262 of the second portion 4222, 4242, 4262 of each third cut 402, 404, 406.

The second portion 3822, 3842, 3862 of each first cut 382, 384, 386 extends along the mean direction D3822, D3842, D3862 that is not parallel respectively to the mean direction D4022, D4042, D4062 along which the second portion 4022, 4042, 4062 of each second cut 402, 404, 406 extends. The second portion 3822, 3842, 3862 of each first cut 382, 384, 386 extends along the mean direction D3822, D3842, D3862 that is not parallel respectively to the mean direction D4222, D4242, D4262 along which the second portion 4222, 4242, 4262 of each third cut 402, 404, 406 extends. The second portion 4022, 4042, 4062 of each second cut 402, 404, 406 extends along the mean direction D4022, D4042, D4062 that is not parallel respectively to the mean direction D4222, D4242, D4262 along which the second portion 4222, 4242, 4262 of each third cut 422, 424, 426 extends.

Each mean direction D3821, D3841, D3861 is not parallel to each mean direction D4022, D4042, D4062. Each mean direction D3823, D3843, D3863 is not parallel to each mean direction D4023, D4043, D4063. Each mean direction D4221, D4241, D4261 is not parallel to each mean direction D3821, D3841, D3861. Each mean direction D4223, D4243, D4263 is not parallel to each mean direction D3823, D3843, D3863. Each mean direction D4221, D4241, D4261 is not parallel to each mean direction D4021, D4041, D4061. Each mean direction D4223, D4243, D4263 is not parallel to each mean direction D4023, D4043, D4063.

The length L3823, L3843, L3863 of the third portion 3823, 3843, 3863 of each first cut 382, 384, 386 is respectively different from, and in this case strictly less than the length L4023, L4043, L4063 of the third portion 4023, 4043, 4063 of each second cut 402, 404, 406. The length L3823, L3843, L3863 of the third portion 3823, 3843, 3863 of each first cut 382, 384, 386 is respectively different from, and in this case strictly less than the length L4223, L4243, L4263 of the third portion 4223, 4243, 4263 of each third cut 402, 404, 406. The length L4023, L4043, L4063 of the third portion 4023, 4043, 4063 of each second cut 402, 404, 406 is respectively different from, and in this case strictly less than the length L4223, L4243, L4263 of the third portion 4223, 4243, 4263 of each third cut 402, 404, 406.

The angles A382, A384 and A386 are substantially equal to one another. The angles B382, B384 and B386 are substantially equal to one another and substantially equal to the angles A382, A384, A386.

The angles A402, A404 and A406 are substantially equal to one another. The angles B402, B404 and B406 are substantially equal to one another and substantially equal to the angles A402, A404, A406.

The angles A422, A424 and A426 are substantially equal to one another. The angles B422, B424 and B426 are substantially equal to one another and substantially equal to the angles A422, A424, A426.

The angles A382, A402 and A422 are substantially equal to one another. The angles B382, B402 and B422 are substantially equal to one another and substantially equal to the angles A382, A402 and A422.

The angles A384, A404 and A424 are substantially equal to one another. The angles B384, B404 and B424 are substantially equal to one another and substantially equal to the angles A384, A404 and A424.

The angles A386, A406 and A426 are substantially equal to one another. The angles B386, B406 and B426 are substantially equal to one another and substantially equal to the angles A386, A406 and A426.

In this case, A382=A402=A422=B382=B402=B422=A384=A404=A424=B384=B404=B424=A4 06=A 426=B386=B406=B426=54°.

FIG. 14 shows a pair according to the invention of a first tyre 10′ and a second tyre 10″. In this figure, elements similar to those shown in the preceding figures are denoted by identical or similar references.

The first and second tyres have markings indicating the same trade name, in this case MICHELIN® and markings indicating the same model, in this case PRIMACY®.

The first tyre 10′ is of the size 205/55R16 while the second tyre 10″ is of the size 255/60R18. Thus, the first tyre has a nominal section width (in this case 205) that is strictly less than the nominal section width (in this case 255) of the second tyre.

The first tyre 10′ comprises three first circumferential ribs 28′, 30′, 32′ that each have an axial length 128′, 130′, 132′ such that 128′=130′=132′=28 mm. The second tyre 10″ comprises three second circumferential ribs 28″, 30″, 32″ that each have an axial length 128″, 130″, 132″ such that 128″=130″=|32″=35 mm. Thus, each first circumferential rib 28′, 30′, 32′ has an axial length strictly greater than the axial length of each second circumferential rib 28″, 30″, 32″.

The first tyre 10′ comprises first cuts 38′, 40′ and 42′ made respectively in each first circumferential rib 28′, 30′, 32′. The cuts 40′, 42′ are identical to the cuts 40 in the tyre according to the above-described first embodiment. The features of the cuts 38′ can be inferred, mutatis mutandis, from those of the cuts 40′, 42′ by inversion with respect to a plane perpendicular to the axis of rotation of the tyre, parallel to the median plane M and passing through the circumferential cut 20′.

The second tyre 10″ comprises second cuts 38″, 40″ and 42″ made respectively in each second circumferential rib 28″, 30″, 32″. The cuts 40″, 42″ are identical to the cuts 42 in the tyre according to the above-described first embodiment. The features of the cuts 38″ can be inferred, mutatis mutandis, from those of the cuts 40″, 42″ by inversion with respect to a plane perpendicular to the axis of rotation of the tyre, parallel to the median plane M and passing through the circumferential cut 20′.

1.-11. (canceled)

12. A pair of a first tire and a second tire,
the first tire comprising a first tread comprising cuts comprising a first cut made in a first circumferential rib delimited by first and second circumferential cuts axially adjacent to the first circumferential rib,
the second tire comprising a second tread comprising cuts comprising a second cut made in a second circumferential rib delimited by first and second circumferential cuts axially adjacent to the second circumferential rib,
the cuts made in each first and second circumferential rib opening into each of the first and second circumferential cuts delimiting the first or second circumferential rib respectively in first and second opening zones, an azimuth of a point of the first opening zone of a cut made in the first or second circumferential rib being substantially aligned circumferentially with an azimuth of a point of the second opening zone of another cut made in the first or second circumferential rib,
each first and second cut comprising first, second and third portions, the first portion and the second portion of each first and second cut being joined directly together by a first inflection zone, the second portion and the third portion of each first and second cut being joined directly together by a second inflection zone, the second portion of each first and second cut being arranged axially between the first and third portions respectively of each first and second cut,
a mean direction of the first portion of each first and second cut not being parallel to a mean direction of the second portion respectively of each first and second cut,
a mean direction of the third portion of each first and second cut not being parallel to the mean direction of the second portion respectively of each first and second cut,
the first cut having a length along an axial direction that is different from a length along the axial direction of the second cut,
an angle formed by the mean direction of the first portion and the mean direction of the second portion of the first cut being substantially equal to an angle formed by the mean direction of the first portion and the mean direction of the second portion of the second cut,
an angle formed by the mean direction of the second portion and the mean direction of the third portion of the first cut being substantially equal to an angle formed by the mean direction of the second portion and the mean direction of the third portion of the second cut,
a length of the second portion of the first cut being substantially equal to a length of the second portion of the second cut,
the second portion of the first cut extending along the mean direction that is not parallel to the mean direction along which the second portion of the second cut extends, and/or a length of the first portion of the first cut being different from a length of the first portion of the second cut and/or a length of the third portion of the first cut being different from a length of the third portion of the second cut.

13. A tire comprising a tread comprising cuts comprising:
a first cut made in a first circumferential rib delimited by first and second circumferential cuts axially adjacent to the first circumferential rib;
a second cut made in a second circumferential rib delimited by first and second circumferential cuts axially adjacent to the second circumferential rib,
the cuts made in each first and second circumferential rib opening into each of the first and second circumferential cuts delimiting the first or second circumferential rib respectively in first and second opening zones, an azimuth of a point of the first opening zone of a cut made in the first or second circumferential rib being substantially aligned circumferentially with an azimuth of a point of the second opening zone of another cut made in the first or second circumferential rib,
each first and second cut comprising first, second and third portions, the first portion and the second portion of each first and second cut being joined directly together by a first inflection zone, the second portion and the third portion of each first and second cut being joined directly together by a second inflection zone, the second portion of each first and second cut being arranged axially between the first and third portions respectively of each first and second cut,
a mean direction of the first portion of each first and second cut not being parallel to a mean direction of the second portion respectively of each first and second cut,
a mean direction of the third portion of each first and second cut not being parallel to the mean direction of the second portion respectively of each first and second cut,
the first cut having a length along an axial direction that is different from a length along the axial direction of the second cut,
an angle formed by the mean direction of the first portion and the mean direction of the second portion of the first cut being substantially equal to an angle formed by the mean direction of the first portion and the mean direction of the second portion of the second cut,
an angle formed by the mean direction of the second portion and the mean direction of the third portion of the first cut being substantially equal to an angle formed by the mean direction of the second portion and the mean direction of the third portion of the second cut,
a length of the second portion of the first cut being substantially equal to a length of the second portion of the second cut,
the second portion of the first cut extending along the mean direction that is not parallel to the mean direction along which the second portion of the second cut extends, and/or a length of the first portion of the first cut being different from a length of the first portion of the second cut and/or a length of the third portion of the first cut being different from a length of the third portion of the second cut.

14. The pair according to claim 12, wherein the first cut has a length along a circumferential direction substantially equal to a length along the circumferential direction of the second cut.

15. The pair according to claim 12, wherein, with the second portion of the first cut extending along the mean direction that is not parallel to the mean direction along which the second portion of the second cut extends:
the first portion of the first cut extends along a mean direction that is not parallel to the mean direction along which the first portion of the second cut extends, and
the third portion of the first cut extends along a mean direction that is not parallel to the mean direction along which the third portion of the second cut extends.

16. The pair according to claim 12, wherein, with the first cut having the length along the axial direction that is strictly less than the length along the axial direction of the second cut:
the length of the first portion of the first cut is strictly less than the length of the first portion of the second cut, and/or
the length of the third portion of the first cut is strictly less than the length of the third portion of the second cut.

17. The pair according to claim 12, wherein the angle formed by the mean direction of the first portion and the mean direction of the second portion of each first and second cut is substantially equal to the angle formed by the mean direction of the second portion and the mean direction of the third portion of each first and second cut.

18. The tire according to claim 13, wherein the first cut has a length along a circumferential direction substantially equal to a length along the circumferential direction of the second cut.

19. The tire according to claim 13, wherein, with the second portion of the first cut extending along the mean direction that is not parallel to the mean direction along which the second portion of the second cut extends:
the first portion of the first cut extends along a mean direction that is not parallel to the mean direction along which the first portion of the second cut extends, and
the third portion of the first cut extends along a mean direction that is not parallel to the mean direction along which the third portion of the second cut extends.

20. The tire according to claim 13, wherein, with the first cut having the length along the axial direction that is strictly less than the length along the axial direction of the second cut:
the length of the first portion of the first cut is strictly less than the length of the first portion of the second cut, and/or
the length of the third portion of the first cut is strictly less than the length of the third portion of the second cut.

21. The tire according to claim 13, wherein the angle formed by the mean direction of the first portion and the mean direction of the second portion of each first and second cut is substantially equal to the angle formed by the mean direction of the second portion and the mean direction of the third portion of each first and second cut.

22. The tire according to claim 13, further comprising a third cut made in a third circumferential rib delimited by first and second circumferential cuts axially adjacent to the third circumferential rib,
the cuts made in the third circumferential rib opening into each of the first and second circumferential cuts delimiting the third circumferential rib respectively in first and second opening zones, an azimuth of a point of the first opening zone of a cut made in the third circumferential rib being substantially aligned circumferentially with an azimuth of a point of the second opening zone of another cut made in the third circumferential rib,
the third cut comprising first, second and third portions, the first portion and the second portion of the third cut being joined directly together by a first inflection zone, the second portion and the third portion of the third cut being joined directly together by a second inflection zone, the second portion of the third cut being arranged axially between the first and third portions of the third cut,
a mean direction of the first portion of the third cut not being parallel to a mean direction of the second portion of the third cut,
a mean direction of the third portion of the third cut not being parallel to the mean direction of the second portion of the third cut,
the third cut having a length along the axial direction that is different from the length along the axial direction of each first and second cut,
an angle formed by a mean direction of the first portion and a mean direction of the second portion of the third cut being substantially equal to the angle formed by the mean direction of the first portion and the mean direction of the second portion of each first and second cut,
an angle formed by the mean direction of the second portion and a mean direction of the third portion of the third cut being substantially equal to an angle formed by the mean direction of the second portion and the mean direction of the third portion of each first and second cut, a length of the second portion of the third cut being substantially equal to the length of the second portion of each first and second cut,
the second portion of the third cut extending along the mean direction that is not parallel to the mean direction along which the second portion of each first and second cut extends, and/or a length of the first portion of the third cut being different from the length of the first portion of each first and second cut and/or a length of the third portion of the third cut being different from the length of the third portion of each first and second cut.

23. The tire according to claim 22, wherein the third cut has a length along a circumferential direction substantially equal to a length along the circumferential direction of each first and second cut.

24. The tire according to claim 22, wherein, with the second portion of the third cut extending along the mean direction that is not parallel to the mean direction along which the second portion of each first and second cut extends:
the first portion of the third cut extends along a mean direction that is not parallel to the mean direction of the first portion of each first and second cut, and
the third portion of the third cut extends along a mean direction that is not parallel to the mean direction of the third portion of each first and second cut.

25. The tire according to claim 22, wherein, with the first cut having a length along the axial direction strictly less than the length along the axial direction of the second cut and the second cut having a length along the axial direction strictly less than the length along the axial direction of the third cut:
the length of the first portion of the first cut is strictly less than the length of the first portion of the second cut and the length of the first portion of the second cut is strictly less than the length of the first portion of the third cut, and/or
the length of the third portion of the first cut is strictly less than the length of the third portion of the second cut and the length of the third portion of the second cut is strictly less than the length of the third portion of the third cut.

26. The tire according to claim 22, wherein an angle formed by the mean direction of the first portion and the mean direction of the second portion of the third cut is substantially equal to an angle formed by the mean direction of the second portion and the mean direction of the third portion respectively of the third cut.
